(19) United States
(12) Patent Application Publication
(10) Pub. No.: US 2023/0405737 A1
(43) Pub. Date: Dec. 21, 2023

(54) WELDING SYSTEM AND METHOD FOR USE

(71) Applicant: Weldingdroid ApS, Vejen (DK)

(72) Inventors: Kevin Eggert CHRISTENSEN, Rødding (DK); Christian JUEL OLSEN, Vejen (DK)

(21) Appl. No.: 18/031,515

(22) PCT Filed: Oct. 13, 2021
(86) PCT No.: PCT/DK2021/050306

§ 371 Date: Apr. 12, 2023

(30) Foreign Application Priority Data
Oct. 13, 2020 (DK) PA 2020 70689

(51) Int. Cl. B23K 37/02

(52) U.S. Cl. CPC B23K 37/0282; B23K 37/0264

(57) ABSTRACT

The present invention discloses a welding system, particular a welding system using an inert gas in order to provide an oxide free fusion zone, where the object to be welded has a first side and a second side, said first and second sides being opposite sides of the object to be welded, where the system comprises: —a first wagon, in use suitable to be arranged on a first side of the object to be welded, where said wagon comprises means for remaining on the surface of the object to be welded, and being able to travel on the surface of the object to be welded, where a first welding device is arranged in connection to or on said wagon; —a slave wagon, in use suitable to be arranged on a second side of the object to be welded, where said slave wagon comprises a tub, said tub having an upper rim adapted to the contour of the object to be welded, and where further a gas inlet is provided such that a suitable gas may be introduced into the tub, and where the slave wagon comprises means such that in use the rim of the tub on the slave wagon may remain proximate the second side of the object to be welded, and where means are provided for moving the slave wagon such that the tub is superposed the fusion zone on the object to be welded.

### CROSS-REFERENCE TO RELATED APPLICATIONS

This application claims priority to PCT Application No. PCT/DK2021/050306, having a filing date of Oct. 13, 2021, which is based DK Application No. PA 2020 70689, having a filing date of Oct. 13, 2020, the entire contents both of which are hereby incorporated by reference.

### FIELD OF TECHNOLOGY

The following relates to a welding system as well a method for using such a welding system.

### BACKGROUND

The welding technique for which embodiments of the present invention find particularly use is the type of welding where an inert gas is provided surrounding the fusion zone in order to avoid oxidation during the welding process. In this context, the fusion zone shall be understood as the zone where the metals to be welded together/fused together is heated to such a degree that fusion occurs. Furthermore, the term fusion may include both welding techniques taking place without the addition of additional material or welding processes where additional welding material is supplied during the welding process.

It is well known in the conventional art to use protective inert gases surrounding welding zones in order to create an oxide free welding process whereby the fusion between the two materials or parts of materials which it is desirable to weld together are fused together in the cleanest and strongest possible manner. A typical inert gas for this purpose is argon but embodiments of the present invention are suitable to be carried out with any type of inert gas usable for fusion welding.

WO 2016/186743 discloses a welding system using an inert gas in order to provide an oxide free fusion zone, where the object to be welded has a first side and a second side, the first and second sides being opposite sides of the object to be welded, where the system comprises:
a robotic system able to travel on the surface of the object to be welded, where a welding torch is provided;
a tub, the tub having an upper rim adapted to the contour of the object to be welded, and where a gas inlet is provided such that a suitable gas may be introduced into the tub.

A particular problem arises when for example welding together two sections of pipe in that it is necessary to remove oxygen both from the outer side of the pipe and also from the inner side of the pipe. In order to assure that no oxygen is present inside the pipe, it is customary to plug the open ends of the pipe on either side of the welding zone and then fill the space between the plugs with the inert gas. This in return requires a substantial amount of gas and at the same time due to the two pieces of pipe not being assembled in a tight manner, there will be leakage of gas through the small crevice between the two ends of the pipes.

In other examples where it is desirable to weld two pieces together, it may be cumbersome or directly impossible to create an oxygen free environment on the back side of the welding zone for example inside tanks or the like.

### SUMMARY

An aspect relates to a solution to this problem, which is both very effective, assures that an oxygen free environment is present surrounding the fusion zone both on the outside and the inside of the objects to be welded and which requires a significantly lesser amount of gas in order to create a superior welding seam for these types of welds.

Embodiments of the invention address this by providing a welding system using an inert gas in order to provide an oxide free fusion zone, where the object to be welded has a first side and a second side, the first and second sides being opposite sides of the object to be welded, where the system comprises:
a first wagon, in use suitable to be arranged on a first side of the object to be welded, where the wagon comprises means for remaining on the surface of the object to be welded, and being able to travel on the surface of the object to be welded, where a first welding device is arranged in connection to or on the wagon;
a slave wagon, in use suitable to be arranged on a second side of the object to be welded, where the slave wagon comprises a tub, the tub having an upper rim adapted to the contour of the object to be welded, and where further a gas inlet is provided such that a suitable gas may be introduced into the tub, and where the slave wagon comprises means such that in use the rim of the tub on the slave wagon may remain proximate the second side of the object to be welded, and where means are provided for moving the slave wagon such that the tub is superposed the fusion zone on the object to be welded.

By using this system, only the tub needs to be filled with the inert gas and furthermore, the tub has to be positioned such that it completely surrounds and saturates the fusion zone with inert gas. The slave wagon's means for being positioned on the second side of the object in combination with the ability of the slave wagon to move with the fusion zone assures that the inert gas in the tub will be present covering the fusion zone at all times. At the same time, as the rim of the tub is positioned very close to the surface of the second side, only a small amount (if any) of inert gas leaks from the tub and as such the amount of gas necessary in order to carry out a successful and a high-quality weld is minimal.

As compared to the conventional art, for example as disclosed in WO 2016/186743 embodiments of the present invention are distinguished by providing a wagon on either side of the surface which is to be welded. The wagons are in contact with the surfaces and may in some embodiments be provided with means for travelling on the surface. Consequently, better quality welds are achieved.

In a further embodiment, the means provided in the first wagon in order for the first wagon to remain on the first surface comprises magnets; and where the means on the slave wagon provided in order to retain the rim of the tub proximate the second side of the object to be welded comprises magnets.

The arrangement of mutual magnets both on the first wagon and on the slave wagon creating mutual attraction through the object to be welded assures that the slave wagon being on the inaccessible second side of the object to be welded is correctly positioned. It is a rather simple task for the skilled person to assure that the distance between the welding device and the magnet corresponds to the distance between for example the centre of the tub and the magnets on the slave wagon. In this manner it is assured that the magnets align the first wagon and slave wagon and assures that the welding device is superposed the welding tub. This alignment may further be assured by arranging a plurality of magnets for example having a specific sequence of polarisation such that the slave wagon can only have one orientation relative to the first wagon. Test on prototypes with magnets have indicated that the system using conventional magnets may be used up to objects having a material thickness of 20 mm or more. It is clear that by using other types of magnets such as for example electro-magnet or neodymium magnets either thicker materials may be welded or smaller magnets may be used.

In a further embodiment of the invention the first wagon and/or the slave wagon are provided with wheels, unidirectional rollers or ball bearings in order for the wagon and/or slave wagon to be able to travel on the surfaces of the object to be welded.

It is clear that by providing wheels, unidirectional rollers or ball bearings the friction between the first wagon and the slave wagon relative to the surface of the object to be welded is greatly reduced. This provides a smoother movement of the first wagon and the slave wagon and as such facilitates a continuous welding process with an even and smooth weld as results. As the wheels and particularly the unidirectional rollers or ball bearings allow the first wagon and slave wagon to be movable in any desired direction, it is possible to carry out non-linear welds which may for example be required when assembling tanks, non-symmetrical three-dimensional objects and the like. Furthermore, even though the first wagon may be provided with wheels, unidirectional rollers or ball bearings allowing movement in any desired direction, the first wagon will typically be arranged in a gurney assuring that the welding device remains in a well-defined position. By for example rotating the pipe sections to be welded together relative to the welding device, the first device may be stationary whereas the slave wagon will travel on the inside due to the magnetic attraction with the magnets in the first wagon such that the tub travels along the fusion zone as the pipe sections are rotated.

Alternatively, the first and second wagons may be provided with skids, in order to be able to slide on the surfaces of the objects to be welded.

The rim of the tub is arranged 1 to 8 mm from the second side of the object to be welded. By this close proximity of the rim of the tub to the second side of the object, leakage of inert gas is minimized without the tub interfering with the second side of the object. Furthermore, in cases where the object to be welded is a pipe section, the upper rim of the tub may be shaped congruent to the inner side of the pipe section such that the small distance may be kept all along the rim of the tub even though that the object to be welded has a circular cross section. Off course when desiring to weld other shapes such as for example balls or spheres, the rim of the tub may be shaped accordingly.

When desiring to weld objects having a substantial thickness, it may be desirable to arrange welding devices on both sides of the fusion zone. Embodiments of the present invention addresses this by providing a second welding device arranged inside the tub on the slave wagon, such that in use the first welding device on the first wagon and the second welding device on the slave wagon may be arranged such that welding is performed on a common fusion zone.

In a further embodiment of the invention, the welding device comprises a welding electrode to be positioned proximate the fusion zone, and where an optical device is arranged focused on the tip of the welding electrode's position relative to the fusion zone, and where means are provided for adjusting the welding electrode's tip relative to the fusion zone.

The provision of means for example in the shape of an IR camera or an optical (normal) camera provides the possibility of checking the progress and position of the welding zone such that an accurate welding seam may be performed. As the fusion zone and particularly the engagement between the arch from the welding electrode and the surface of the material to be welded will be the hottest spot in the fusion zone, an IR camera will be able to detect precisely where the welding is performed. Small inaccuracies may occur due to the relative movement between the welding device and the object to be welded and as such by being able to control it in a continuous manner it is also possible to readjust the position of the welding electrode continuously and thereby assure that the weld seam is performed at the desired position.

In a further embodiment of this aspect, the means for adjusting the position of the tip of the welding electrode relative to the fusion zone, is preprogrammed, and the means may adjust the position according to stored data relating to the weld to be performed or where the electrode tip's position is detected and compared to an optimal preprogrammed weld contour causing the means to adjust the position of the tip.

The preprogramming may include slight oscillations of the electrode relative to the desired weld seam such that a broader weld may be performed for example by criss-crossing the electrode across the interface between two objects to be welded together. Also depending on the materials to be welded together and the thickness of the material, certain tolerances in the position of the electrode's tip relative to the interface between the objects to be welded together may be tolerated without adjusting the electrode tip's position. However, if the tip of the electrode comes off course or may erroneously be positioned slightly off the interface between the two objects to be welded together such that an imperfect weld may result, the means will quickly and continuously correct the position of the electrode's tip relative to the desired weld seam and create the weld fusion zone in the correct position relative to the objects.

Embodiments of the invention are also directed to a method of welding two objects together where the object to be welded has a first side and a second side, the first and second sides being opposite sides of the object to be welded, where the system comprises:
a first wagon, in use suitable to be arranged on a first side of the object to be welded, where the wagon comprises means in the shape of one or more magnets for remaining on the surface of the object to be welded, and being able to travel on the surface of the object to be welded, where a welding device is arranged in connection to or on the wagon;
a slave wagon, in use suitable to be arranged on a second side of the object to be welded, where the slave wagon comprises a tub, the tub having an upper rim adapted to the contour of the object to be welded, and where further a gas inlet is provided such that a suitable gas may be introduced into the tub, and where the slave wagon comprises means in the shape of one or more magnets such that in use the rim of the tub on the slave wagon may remain proximate the second side of the object to be welded, and where means are provided for moving the slave wagon such that the tub is superposed the fusion zone on the object to be welded.
where
   the two objects to be welded are arranged in the correct relative position to be welded defining a welding zone between the two objects;
   the first wagon is positioned on the first side of one object at a free edge of the object:
   the slave wagon is positioned on the second side of the object such that the one or more magnets provided on the first wagon and the slave wagon attracts each other, thereby positioning the welding device on the first wagon superposed the tub on the slave wagon;
   moving the first wagon and the slave wagon to the position to be welded and
   filling the tub with an inert gas and
   activating the welding device including providing an inert gas surrounding the fusion zone
   moving the first wagon and the slave wagon along the welding zone as the welding process progresses.

In embodiments, the method provides a further welding device on the second side of the object to be welded. The further welding device may be arranged in the tub or the welding device may be provided with an inert gas facility such that the fusion zone may be welded from both the first and the second sides simultaneously. This embodiment of the invention is particularly advantageous for welds of thicker materials or where an especially thick weld seam is required.

### BRIEF DESCRIPTION

Some of the embodiments will be described in detail, with references to the following Figures, wherein like designations denote like members, wherein:

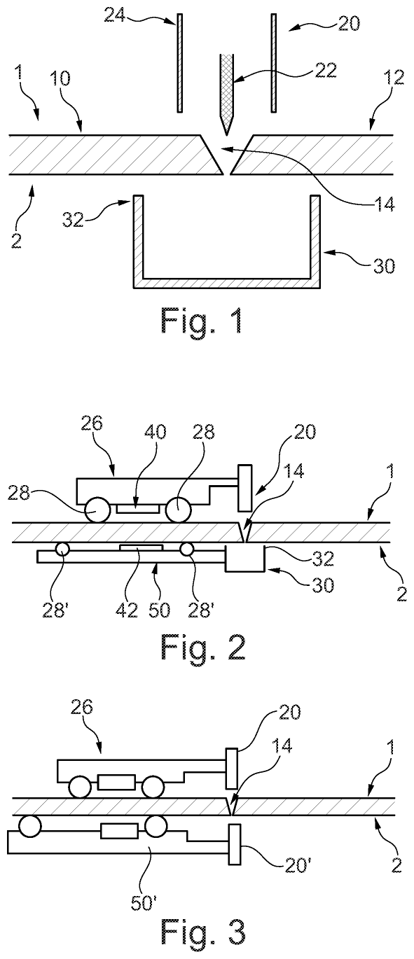

FIG. 1 illustrates the principle of welding as carried out by embodiments of the present invention;

FIG. 2 illustrates a cross section where the welding device is arranged superposed the gap on the first side of the objects to be welded; and

FIG. 3 illustrates that the slave wagon also comprises a welding device arranged such that the two welding devices will weld on either side of the gap creating respective fusion zones.

### DETAILED DESCRIPTION

In FIG. 1 the principle of welding as carried out by embodiments of the present invention is schematically illustrated. Two objects 10, 12 are arranged in close proximity to each other such that at very narrow gap/crevice 14 is provided between the two objects. Above the gap 14, a welding tool 20 is positioned which comprises an electrode 22 as well as a shield 24 surrounding the electrode 22. Between the shield 24 and the objects 10, 12 an inert gas will be present in order to remove/replace oxygen from the gap which constitutes the fusion zone. The fusion zone furthermore also expands into parts of the object 10, 12 in that the object of the welding process is to fuse the two objects 10, 12 together. By creating a relatively high voltage between the electrode and the objects, a welding arch will be created between the electrode 22 and the material of the objects 10, 12 which will melt the material of the objects 10, 12 thereby creating a fusion between the two objects 10, 12. In order to achieve a clean fusion zone and having the melt without reactive components the inert gas supplied inside the shield 24 will avoid the materials of the objects 10, 12 to react with oxygen thereby creating welding slags. The electrode may be for example a Wolfram electrode which will create the arch and melt the material of the objects 10, 12 or it may be a sacrificial electrode adding material to the gap during the welding process.

In order to avoid any pollution of the weld and thereby substantially lowering the quality of the weld on the second side 2 of the objects to be welded a protective inert gas is provided to replace oxygen in the fusion zone.

For this purpose, a tub 30 is provided adjacent the second side 2 of the objects 10, 12 to be welded. The rim 32 is arranged in close proximity to the second surface of the objects 10, 12 such that an inert gas arranged inside the tub 30 will only have a very narrow possibility of escaping the tub 30 but at the same time it is possible to move the tub 30 along the weld seam defined by the gap 14.

In FIG. 2 is illustrated a cross section where the welding device 20 is arranged superposed the gap 14 on the first side 1 of the objects to be welded. The welding device 20 is arranged on a first wagon 26. The wagon 26 is provided with wheels or balls 28 such that the first wagon 26 may move along the first surface 1. In this manner it is possible for the welding device 20 to follow the progress of the welding as the welding seam in the gap 14 is created.

In order to maintain the first wagon 26 in close contact with the object to be welded, a magnet 40 is provided on the wagon. The magnet 40 will assure that the first wagon 26 is always in contact with the first surface of the objects to be welded and due to the low friction characteristics of the balls/wheels 28, the first wagon 26 will be able to move on the first surface. On the second surface which is typically inside a pipe or tank or the like, a slave wagon 50 is provided. The slave wagon 50 is also equipped with rollers or balls 28′ such that the slave wagon 50 can travel on the second side of the objects to be welded. Connected to the slave wagon 50 is the tub 30, where the rim of the tub 32 is in close proximity to the second surface 2. Furthermore, a magnet 42 is provided on the slave wagon such that as the first wagon is positioned relative to the slave wagon, the two magnets 40, 42 will create mutual attraction such that the slave wagon due to the position of the magnet 42 will always be positioned in the relative same position relative to the first wagon 26. This means that if the first wagon 26 moves on the first surface 1, the mutual attraction between the magnet 40, 42 will cause the slave wagon 50 to carry out the same movement. Consequently, by guiding the welding device 20 along the gap of the intended welding seam, the tub 30 will due to the movement as described above also always be kept in the same position relative to the gap/fusion zone 14, whereby it is assured that the inert gas is present on either side of the fusion zone/gap 14 due to shield 24, see FIG. 1, provided on the welding device and the tub 30 provided on the slave wagon. In this manner, a very limited amount of gas is needed inside the tub in order to create an oxygen free fusion zone compared to filling the entire pipe section with the inert gas.

In further embodiments of the invention, the slave wagon 50′ as indicated in FIG. 3 also comprises a welding device 20′ arranged such that the two welding devices 20, 20′ will weld on either side of the gap 14 creating respective fusion zones which may overlap thereby providing a strong welding zone. As the welding device 20′ as was the case with the welding device 20 as discussed in relation with FIG. 1 is provided with a shield containing an inert gas surrounding the electrode and the fusions zone, it is also achieved that a substantially oxygen free welding zone around the fusion zone/gap 14 is provided on the second side 2 of the objects to be welded. In this embodiment the shield creates the tub.

In order to guide the first wagon, a robotic arm (not illustrated) may be attached to the first wagon 26 where software controlling the robotic arm directs the robotic arm to move the first wagon in a desired manner for example along a gap between two objects to be welded. The first wagon and also possibly the slave wagon may be provided with sensors for example in the shape of optical means such as a camera or an infrared sensor in order to detect the exact location of the fusion zone. Data from the sensors may be fed to the control unit controlling the robotic arm such that any deviation between the positioning of the welding devices 20, 20′ relative to the desired position where the welding/fusion is to take place illustrated by the gap may be corrected automatically due to the registration by the sensor of the fusion zone relative to the predefined weld. The first wagon may furthermore be provided with an additional sensor or the same sensor may be used in order to detect where on the first surface it is desirable to create a fusion zone welding the two objects together. This may be optical means being preprogramed to recognize a crevice in the surface being an indication of where the edges of the two objects to be welded are positioned. In this manner the control box may guide the robot arm and thereby the first wagon into a position such that the fusion zone is at all times superposed the detected weld zone.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A welding system, where the object to be welded has a first side and a second side, the first and second sides being opposite sides of the object be welded, where the system further comprising:
a first wagon, in use suitable to be arranged on a first side of the object to be welded, where the wagon remains on the surface of the object to be welded, and being able to travel on the surface of the object to be welded, where a first welding device is arranged in connection to or the on wagon;
a slave wagon provided, in use suitable to be arranged on a second side of the object to be welded, where the slave wagon includes a tub, the tub having an upper rim configured to the contour of the object to be welded, and where further a gas inlet is provided such that a suitable gas may be introduced into the tub, and where the slave wagon in use, the rim of the tub on the slave wagon may remain proximate the second side of the object to be welded, and where the slave wagon moves such that the tub is superposed the fusion zone on the object to be welded.

2. The welding system according to claim 1, wherein the first wagon to remains on the first surface using magnets; and where the slave wagon in order to retain the rim of the tub proximate the second side of the object to be welded comprises magnets.

3. The welding system according to claim 1, wherein the first wagon and/or the slave wagon are provided with wheels, unidirectional rollers or ball bearings in order for the wagon and/or slave wagon to be able to travel on the surfaces of the object be welded.

4. The welding system according to claim 2, wherein the magnets on the first wagon attracts the magnets on the slave wagon, such that the magnets on the first wagon always are superposed the magnets on the slave wagon.

5. The welding system according to claim 1, wherein the rim of the tub is arranged 1 to 8 mm from the second side of the object be welded.

6. The welding system according to claim 1, wherein the object to be welded is the connection between two pipe sections, the pipes having a circular, semi-circular, oval, square or other geometrical cross section, and where the first side is the outside of the pipe sections, and where the inner side of the pipe sections is the second side.

7. The welding system according to claim 1, wherein a second welding device is arranged inside the tub on the slave wagon, such that in use the first welding device the first wagon and the second welding device on the slave wagon may be arranged such that welding is performed on a common fusion zone.

8. The welding system according to claim 1, wherein the welding device comprises a welding electrode to be positioned proximate the fusion zone, and where an optical device is arranged focused on the tip of the welding electrode's position relative to the fusion zone, and where means are provided for adjusting the welding electrode's tip relative to the fusion zone.

9. The welding system according to claim 8, wherein the means for adjusting the position of the tip of the welding electrode relative to the fusion zone, is preprogrammed, and the means may adjust the position according to stored data relating to the weld to be performed or where the electrode tip's position is detected and compared to an optimal preprogrammed weld contour causing the means to adjust the position of the tip.

10. The method of welding two objects together where the object to be welded has a first side and a second side, the first and second sides being opposite sides of the object be welded, where the system further comprising:
a first wagon, in use suitable to be arranged on a first side of the object to be welded, where the wagon comprises one or more magnets for remaining on the surface of the object to be welded, and being able to travel on the surface of the object to be welded, where a welding device is arranged in connection to or on the wagon;
a slave wagon, in use suitable to be arranged on a second side of the object to be welded, where the slave wagon comprises a tub, the tub having an upper rim configured to the contour of the object to be welded, and where further a gas inlet is provided such that a suitable gas may be introduced into the tub, and where the slave wagon comprises one or more magnets such that in use the rim of the tub on the slave wagon may remain proximate the second side of the object to be welded, and where means are provided for moving the slave wagon such that the tub is superposed the fusion zone on the object to be welded where
two objects to be welded are arranged in the correct relative position to be welded defining a welding zone between the two objects;
the first wagon is positioned on the first side of one object at a free edge of the object;
the slave wagon is positioned on the second side of the object such that the one or more magnets provided on the first wagon and the slave wagon attracts each other, thereby positioning the welding device on the first wagon superposed the tub on the slave wagon;
moving the first wagon and the slave wagon to the position to be welded;
filling the tub with an inert gas,
activating the welding device including providing an inert gas surrounding the fusion zone; and
moving the first wagon and the slave wagon along the welding zone as the welding process progresses.

11. The method according to claim 10, wherein a further welding device is arranged in the tub, or the further welding device is provided with an inert gas facility, such that the fusion zone may be welded from both the first and second sides simultaneously.
